(19) United States
(12) Patent Application Publication
(10) Pub. No.: US 2003/0002643 A1
(43) Pub. Date: Jan. 2, 2003

(54) Network-attached interactive unified messaging device

(76) Inventors: Richard A. Seibel, Pompton Lakes, NJ (US); Christopher R. Wiener, Morris Plains, NJ (US)

Correspondence Address: PILLSBURY WINTHROP, LLP, P.O. BOX 10500, MCLEAN, VA, 22102, US

(21) Appl. No.: 09/893,734

(22) Filed: Jun. 29, 2001

(51) Int. Cl. H04M 3/42

(52) U.S. Cl. 379/201.02

(57) ABSTRACT

A method and system for an interactive unified messaging device is presented. A call is received by an interactive unified messaging device. The caller is identified by caller ID information. Using the caller ID information, a configuration for the caller is retrieved. The call is then responded to based on the configuration.

### BACKGROUND

1. Field

This invention relates in general to messaging. Specifically, this invention relates to a system and method for unified messaging.

2. General Background and Related Art

The field of messaging has evolved rapidly in recent years, due in large part to advancements in telecommunications technologies. Messaging services, which ensure that messages from a sender are delivered to an absent recipient, have become ubiquitous. Such services include messaging devices intended for home use, such as answering machines or computers equipped with telephonic functions, as well as messaging services offered by service providers, such as voicemail boxes.

Messaging technologies manage recorded messages. Specifically, messages may be accessed in analog form or digital form and retrieved based on various criteria, such as date or time. Unified messaging integrates messaging capabilities on different platforms and enables a user to access and retrieve messages recorded in different modalities and on different platforms. For example, a user may retrieve conventional voice messages via an e-mail box. Similarly, a user may listen to e-mail messages which are read aloud by a text-to-speech (TTS) engine.

Caller ID, a service offered by service providers, sends identifying information of a caller to a callee when the caller places a call. A messaging system may record caller ID data along with a message left by the callee. As such, messages may be indexed and accessed according to caller ID data. For instance, when a voice message is sent to an email box, the associated caller ID data may be sent as well. The caller ID data may be recorded as sender information to facilitate sorting and processing of incoming messages. Additionally, when an e-mail message is read to a user via a TTS engine, the caller ID data may also be read.

Such uses of caller ID are very limited, merely employing caller ID data to facilitate search and retrieval of messages.

Therefore, what is needed is a method and system that uses caller ID data in conjunction with a wider range of messaging functions.

### BRIEF DESCRIPTION OF THE DRAWINGS

FIG. 1 is a high-level diagram of a system according to an embodiment of the present invention.

FIG. 2 is high-level block diagram of a messaging unit according to an embodiment of the present invention.

FIG. 3 is a flow diagram illustrating a method according to an embodiment of the present invention.

### DETAILED DESCRIPTION

The following detailed description refers to the accompanying drawings that illustrate embodiments of the present inventions. Other embodiments are possible and modifications may be made to the embodiments without departing from the spirit and scope of the invention. Therefore, the following detailed description is not meant to limit the invention. Rather, the scope of the invention is defined by the appended claims.

It will be apparent to one of ordinary skill in the art that the embodiments as described below may be implemented in many different embodiments of software, firmware, and hardware in the entities illustrated in the figures. The actual software code or specialized control hardware used to implement the present invention is not limiting of the present invention. Thus, the operation and behavior of the embodiments will be described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Moreover, the processes associated with the presented embodiments may be stored in any storage device, such as, for example, a computer system (non-volatile) memory, an optical disk, magnetic tape, or magnetic disk. Furthermore, the processes may be programmed when the computer system is manufactured or via a computer-readable medium at a later date. Such a medium may include any of the forms listed above with respect to storage devices and may further include, for example, a carrier wave modulated, or otherwise manipulated, to convey instructions that can be read, demodulated/decoded and executed by a computer.

A method and system for an interactive unified messaging device, as described herein, involves receiving a call by an interactive unified messaging device. The caller is identified by caller ID information conveyed with the call. A configuration for the caller is retrieved based on the caller ID information. The call is then responded to based on the configuration of the caller.

A caller may include a party that, for example, places a telephone call or sends an e-mail message. Caller ID information may include a host of information, such as a telephone number, an e-mail address, the name of a caller, or the name of an organization.

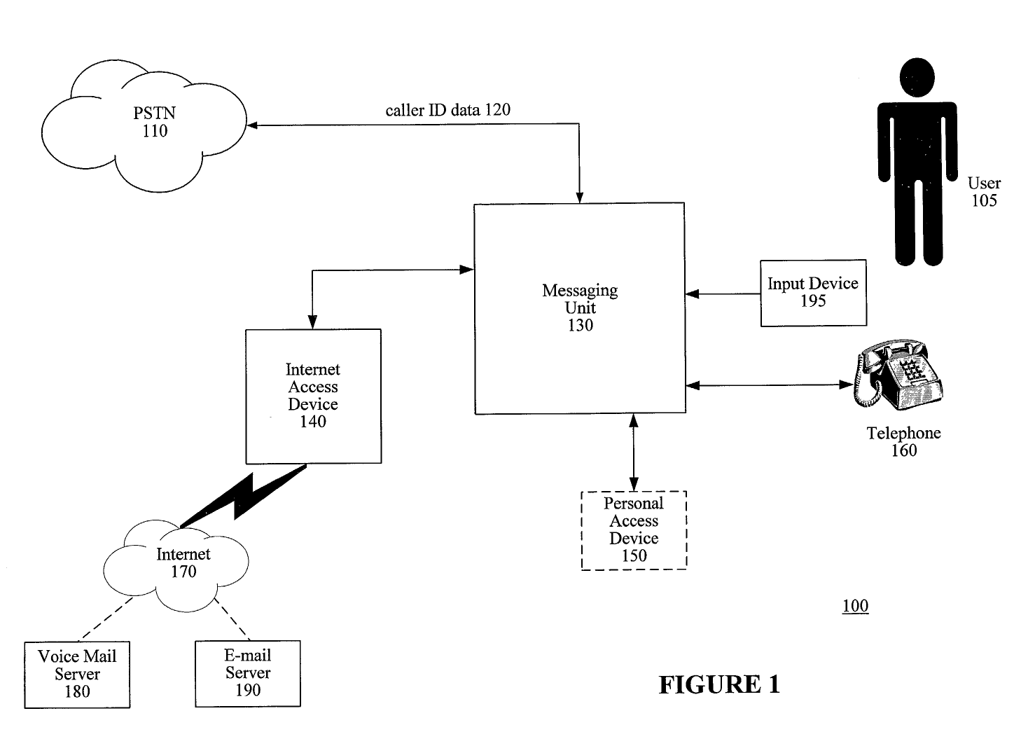

FIG. 1 is a high-level diagram of system 100 according to an embodiment of the present invention. System 100 comprises public switched telephone network (PSTN) 110, messaging unit 130, Internet access device 140, input device 195, and telephone 160.

Messaging unit 130 receives a call originating from PSTN 110. The call conveys caller ID data 120 and other signals, such as audio signals. A configuration for the caller may have been previously stored and associated with the caller's caller ID data 120. As such, messaging unit 130 may retrieve the stored configuration using a portion or all of the caller ID data 120 as an index. Messaging unit 130 may then respond to the call based on the retrieved configuration.

If no caller ID data is available, or the conveyed data does not match to an existing configuration, default rules or configurations may be used to respond to the call. Such rules may be defined by software, user inputs, or a combination thereof. An exemplary default rule may include forwarding the call to voicemail. Alternatively, a user 105 of messaging unit 130, at the time of a call, may be prompted for an input that specifies how the call should be handled.

Processing of the caller ID data and retrieval of a stored configuration, default rules, or user input may occur before telephone 160 rings. Software and firmware in messaging unit 130 may be automatically updated via an Internet connection or automated telephone calls.

Input device 195 may comprise, for example, a keypad, a mouse and keyboard, or a voice recognition input mechanism in a personal computer.

Telephone 160 may comprise, for example, a telephone, a cordless telephone, a telephone handset, or a telephonic device within a computer. In some embodiments, telephone 160 may merely convey voice signals between messaging unit 130 and user 105. Messaging unit 130 may maintain a direct connection with PSTN 110 or act as an intermediary between PSTN 110 and telephone 160. In other embodiments, telephone 160 and messaging unit 130 may be integrated into one device. Additionally, telephone 160 may include a display, a text-to-speech (TTS) processor, or a Braille-based input/output mechanism for visually impaired individuals.

System 100 may comprise Internet access device 140. Internet access device 140 may comprise a computer configured to access the Internet 170. Messaging unit 130 interfaces with Internet access device 140 over a connection, such as over a local area network (LAN). Via the Internet 170, Internet access device 140 may access a host of information resources, such as, for example, voicemail server 180 and e-mail server 190. As such, messaging unit 130 may provide unified messaging capabilities to user 105, wherein messaging unit 130 may transmit to, and receive from, other Internet-connected systems, voicemail messages, e-mail messages, or other such information. Messaging unit 130 may transmit and receive other types of data. For instance, messaging unit 130 may transmit and receive voice signals in a Voice over IP (VoIP) connection between messaging unit 130 and other local and remote nodes. It is to be understood that the present invention may be incorporated into various other settings, such as intranets or PBX-based networks.

System 100 may also include personal access device 150. Personal access device 150 may include a personal computer, a cellular phone, a handheld computing device, or another such device that may control and interact with messaging unit 130. Personal access device 150 may comprise a device that interfaces with messaging unit 130 locally, remotely, or both. It is to be noted that a number of such personal access devices 150 may be interfaced with messaging unit 130. Accordingly, user 105 of messaging unit 130 may issue commands to messaging unit 130, receive messages or status information from messaging unit 130, or effectuate other such exchanges of information. For instance, a user may request status information, input or change a configuration of messaging unit 130, access individual messages, skip messages, play messages, or forward messages, via Internet access device 140, to a remote node connected to Internet 170.

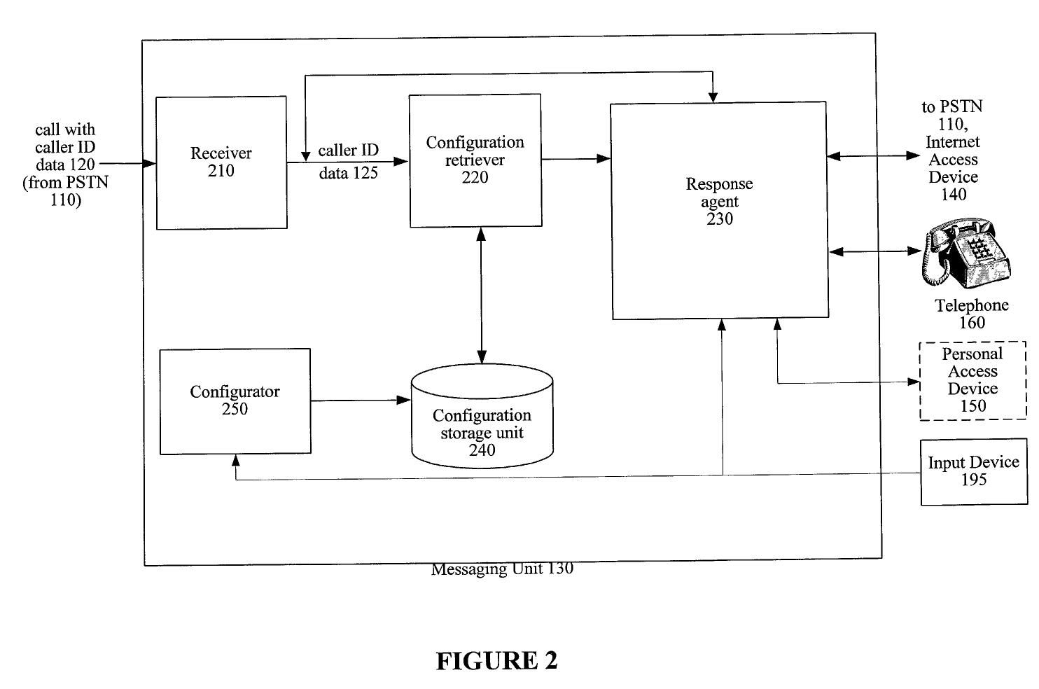

FIG. 2 is a high-level block diagram of messaging unit 130 according to an embodiment of the present invention. Messaging unit 130 may comprise receiver 210, configuration retriever 220, response agent 230, configurator 250, and configuration storage unit 240. It is to be appreciated that configuration storage unit 240, as well as various other components within messaging unit 130, may reside in one or more external locations if messaging unit 130 may access those locations.

Receiver 210 receives a call originating from PSTN 110 that conveys caller ID data 120. Receiver 210 may parse caller ID data 120 to extract information, such as the name of a caller, that may be used by configuration storage unit 240 to index configurations. Configuration retriever 220 receives caller ID data 125 as input. Caller ID data 125 may comprise caller ID data extracted from caller ID data 120 by receiver 210.

Using caller ID data 125 as an index, configuration retriever 220 may access configuration storage unit 240. Response agent 230 may take appropriate action based on configuration information retrieved by configuration retriever 220. Apart from accesses it may make in conjunction with received calls, configuration retriever 220 may also scan configuration storage unit 240 to determine whether actions should be taken with respect to a configuration stored in configuration storage unit 240. For example, configuration retriever 220 may find that a configuration associated with user 105 indicates that a call should be placed to another party at a prescribed time. Response agent 230 may then place the call at the prescribed time.

Configuration storage unit 240 may store a set of configurations associated with caller ID information. Accordingly, a configuration may be associated with any entity, such as an individual or an organization. For example, configuration storage unit 240 may maintain a configuration for “Public, John Q.” Each configuration may involve various operations or functions, settings, or parameters that may be invoked with respect to a particular caller. In some embodiments, one configuration may exist for each set of caller ID data. In other embodiments, multiple configurations may be set up for one set of caller ID data, with only one configuration being active at a given time. In still other embodiments, configuration storage unit 240 may store a configuration for user 105. Such a configuration may include special options, such as wake-up call functions, which apply to user 105, but not to outside parties.

Configurator 250 may set up a configuration for storage in configuration storage unit 240. Setup may occur automatically, such as through assignment of default actions by the system, manually by user 105, or by a combination of system and user interaction. User 105 may set up a configuration via input device 195, telephone 160, personal access device 150, or other such mechanisms.

In an exemplary implementation, configurations may contain static and dynamic information associated with caller ID information. For instance, a configuration may specify a ringing pattern. Specifically, an exemplary configuration associated with a caller may specify whether telephone 160 should ring when the caller calls, whether telephone 160 should ring a predetermined number of times, or whether telephone 160 should ring with a distinctive sound.

In addition, a configuration may specify customized greetings, recorded by user 105 or the system, that may play depending on the time of day of the call, the day of week, the day of the month, the day of the year, or other inputs, such as, for example, inputs from a scheduling application such as Microsoft Outlook.

Further, a configuration may define forwarding behavior. If user 105 is absent, a call may be forwarded to another telephone number, to voicemail, to e-mail, or to another such destination. Therefore, a user may, specify a mail forwarding option and a mail forwarding address. For instance, a user could specify e-mail and an e-mail address, telephone and a telephone number, or pager and a pager number.

Another configuration option may include customizing response behavior based on scheduling information. For example; if user 105 of messaging unit 130 is on vacation or away from messaging unit 130 for another activity, voicemail messages may be recorded and attached to e-mail messages as digital audio files. The e-mail messages may be sent to user 105 until user 105 returns from vacation. Similarly, if the caller associated with a configuration provides, via DTMF tones, voice recognition, or another input method, his or her availability for the day, messaging unit 130 may automatically place a call to the caller when both the caller and user 105 are available. Additionally, the caller may indicate a time for user 105 to return the call, and messaging unit 130 may automatically return the call at the designated time.

Priority may affect customized response behavior. For instance, when messaging unit 130 needs to place callbacks to multiple callers, the order of the calls may be based on priority. Call filtering may be accomplished in various ways. A caller may be associated with information that indicates the caller's priority; the caller may provide to an access control mechanism (not shown) access control information, such as a password, when placing a call to messaging unit 130. In other embodiments, the caller's configuration may include a priority level. As such, messaging unit 130 may differentiate among various callers.

A configuration may also trigger an event reminder, wherein messaging unit 130 reminds a caller or user 105 of a specified event. The time and nature of the event, and a mechanism through which the event reminder is to be executed, such as a TTS engine, e-mail, or Braille, may also be specified. The event reminder may be executed at system- or user-designated times before or after the event is to occur, such as at one hour intervals preceding the event and at 10 minute intervals after the event has begun.

For instance, messaging unit 130 may place a call to an individual having a configuration in configuration storage unit 240 two hours before a scheduled luncheon between the individual and user 105. The voice signals of the call may be generated by a TTS engine, which may remind the individual that “You have a luncheon at 12:00 noon with Jane. Speak ‘Yes’ or ‘No’ to confirm your attendance.” Messaging unit 130 may also provide user 105 with reminder functions, such as wake-up calls containing a summary of the day's scheduled activities. Messaging unit 130 may interface with appointment software, such as Microsoft Outlook, to effectuate such functions.

In other embodiments, a status or configuration of messaging unit 130 may be retrieved and reported on a medium. For instance, a caller's message may be retrieved from messaging unit 130 or a remote storage device such as a voicemail server 180, e-mail server 190, or a Web page on a Web server connected to Internet 170. In particular, the caller's message may be retrieved from an e-mail message, wherein the voice message is attached thereto as a digital audio file. Statistics relating to the caller may also be retrieved from messaging unit 130, such as the number of calls placed by, or made to, the caller, an average duration of the calls, and preferred callback time.

Status of messaging unit 130 may be reported in various ways, such as by playing back voice messages, displaying the status on a display screen coupled to or incorporated within messaging unit 130, annunciating the status via a TTS engine, and transmitting the status via a Braille-equipped input/output mechanism, a personal computer (PC), or the Internet. It is to be appreciated that personal access device 150 in FIG. 1 may initiate requests for status information. In certain embodiments, messaging unit 130 may spontaneously notify user 105 about status information, such as via personal access device 150.

In other embodiments, after a new caller places a first call to user 105, user 105 may optionally define a new configuration associated with the new caller. Such a configuration may be retrieved when the caller makes subsequent calls to user 105. In another implementation, voice print analysis may be used to identify a caller when the caller's configuration cannot be retrieved from messaging unit 130 on the basis of caller ID information conveyed with the call.

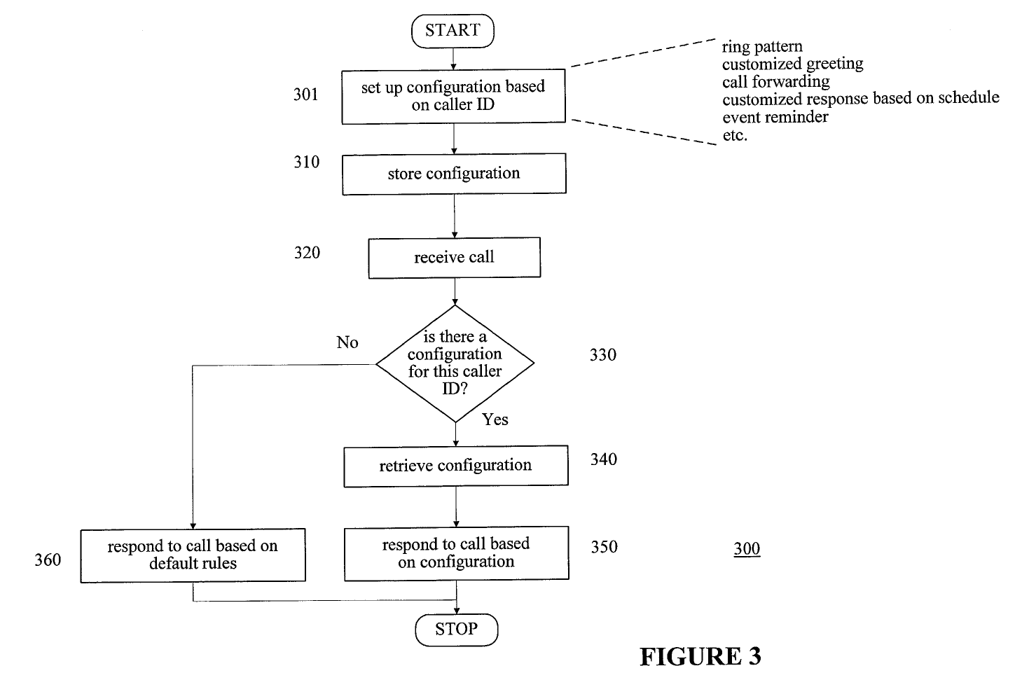

FIG. 3 is a flow diagram illustrating method 300 according to an embodiment of the present invention. In item 301, a configuration is set up based on the caller ID information of a caller. The configuration is stored in item 310. A call is received in item 320. In item 330, method 300 determines whether a stored configuration is associated with the caller ID information. If such a configuration exists, then the configuration is retrieved in item 340. In item 350, the call is responded to based on the retrieved configuration. If a stored configuration is not associated with the caller ID information, then the call is responded to based on default rules in item 360.

The foregoing description of the preferred embodiments is provided to enable any person skilled in the art to make or use the present invention. Various modifications to these embodiments are possible, and the generic principles presented herein may be applied to other embodiments as well. For instance, messaging unit 130 may spontaneously forward received information to user 105, such as e-mail messages received by e-mail server 190 that are designated as urgent.

Further, the invention may be implemented in part or in whole as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a microprocessor or other digital signal processing unit.

As such, the present invention is not intended to be limited to the embodiments shown above but rather is to be accorded the widest scope consistent with the principles and novel features disclosed in any fashion herein.

What is claimed:

1. A method for an interactive unified messaging device, said method comprising:
receiving, by an interactive unified messaging device, a call from a caller, wherein the caller is identified by caller ID information;
retrieving a configuration of said caller based at least in part on said caller ID information; and
responding to the call based at least in part on said configuration of said caller.

2. The method of claim 1, further comprising responding to the call based at least in part on a default configuration if a configuration of said caller is not retrievable.

3. The method of claim 1, further comprising:
setting up an entity configuration associated with an entity and with caller ID information related to the entity; and
storing said entity configuration in a location accessible to said interactive unified messaging device, wherein said entity configuration is retrievable based at least in part on said caller ID information related to the entity.

4. The method of claim 3, wherein said setting up an entity configuration includes at least one of:
specifying a ringing pattern;
recording a customized greeting;
defining forwarding behavior;
customizing response behavior based at least in part on one of scheduling information and caller priority;
setting a schedule for automatic callback; and configuring an event reminder.

5. The method of claim 4, wherein said ringing pattern includes one of a number of rings and a type of ringing sound, and wherein said customized greeting corresponds to one of a predetermined time of a day, time of a week, day of a month, and day of a year.

6. The method of claim 4, wherein said defining forwarding behavior comprises defining a forwarding option and a forwarding address.

7. The method of claim 6, wherein said forwarding option includes one of telephone, e-mail, and pager, and said forwarding address includes one of a telephone number, an e-mail address, and a pager number.

8. The method of claim 4, wherein said scheduling information is associated with a time of return from an activity by a user of said interactive unified messaging device.

9. The method of claim 4, further comprising specifying, by said caller, availability of said caller to receive a return call, and placing, by said interactive unified messaging device, said return call based at least in part on said availability of said caller.

10. The method of claim 4, wherein said caller priority is based at least in part on one of access control information associated with said caller and priority information associated with said caller ID information.

11. The method of claim 4, wherein said configuring an event reminder comprises:
specifying event information;
choosing a mechanism by which said event reminder is to be executed; and
determining a manner in which said event reminder is to be executed.

12. The method of claim 11, wherein said event information includes a time of said event and a nature of said event.

13. The method of claim 11, wherein said mechanism includes one of telephone, e-mail, or Braille.

14. The method of claim 11, wherein said manner includes a time when said event reminder is to be executed.

15. The method of claim 11, further comprising executing said event reminder by said mechanism in said manner.

16. The method of claim 1, further comprising:
retrieving a status of said interactive unified messaging device; and
reporting said status on a medium.

17. The method of claim 16, wherein said status includes one of a message of a caller and statistics related to a caller.

18. The method of claim 17, wherein said statistics include one of number of calls, duration of calls, and preferred callback time.

19. The method of claim 16, wherein said reporting said status includes at least one of playing back a voice message, displaying said status on a display screen, annunciating said status via a text-to-speech engine; and transmitting said status via a Braille mechanism, a personal computer, or the Internet.

20. The method of claim 1, further comprising storing a configuration for a user of said interactive unified messaging device, wherein an option associated with said configuration of said user is unavailable to said caller.

21. An interactive unified messaging device comprising:
a receiver configured to receive a call from a caller, wherein said caller is identified by caller ID information;
a configuration retrieval mechanism arranged to retrieve a configuration of said caller; and
a response agent configured to respond to the call based at least in part on said configuration of said caller.

22. The messaging device of claim 21, further comprising:
a configurator arranged to allow a configuration to be prepared based at least in part on caller ID information; and
a configuration storage mechanism arranged to store said prepared configuration based at least in part on said caller ID information, wherein said prepared configuration is retrievable based at least in part on said caller ID information.

23. The messaging device of claim 21, wherein said response agent is configured to respond to the call based at least in part on a default configuration if a configuration of said caller is not retrievable by said configuration retrieval mechanism.

24. A system for an interactive unified messaging device comprising:
an interactive unified messaging device configured to receive a call from a caller, wherein said caller is identified by caller ID information, to retrieve a configuration of said caller, and to respond to the call based at least in part on said configuration;
a telephone connected to said interactive unified messaging device, said telephone being configured to convey information between a user and said interactive unified messaging device; and
a network access device connected to said interactive unified messaging device, said network access device being configured to access one or more computers connected to a network.

25. The system of claim 24, wherein said network includes the Internet.

26. The system of claim 24, further comprising a personal access device configured to communicate with said interactive messaging device, wherein said user issues commands to said interactive messaging device via said personal access device.

27. A computer-readable medium encoded with a plurality of processor-executable instructions for:
receiving, by an interactive unified messaging device, a call from a caller, wherein the caller is identified by caller ID information;
retrieving a configuration of said caller based at least in part on said caller ID information; and
responding to the call based at least in part on said configuration of said caller.

28. The computer-readable medium of claim 27, further comprising processor-executable instructions for:
setting up an entity configuration associated with an entity and with caller ID information related to the entity; and
storing said entity configuration in a location accessible to said interactive unified messaging device, wherein said entity configuration is retrievable based at least in part on said caller ID information related to the entity.

29. The computer-readable medium of claim 27, further comprising processor-executable instructions for:
retrieving a status of said interactive unified messaging device; and
reporting said status on a medium.
